(19) United States
(12) Patent Application Publication
(10) Pub. No.: US 2019/0019059 A1
(43) Pub. Date: Jan. 17, 2019

(54) METHOD AND APPARATUS FOR IDENTIFYING TARGET

(71) Applicant: Min Jeong LEE, Seoul (KR)

(72) Inventor: Min Jeong LEE, Seoul (KR)

(21) Appl. No.: 15/684,501

(22) Filed: Aug. 23, 2017

(30) Foreign Application Priority Data
Jul. 12, 2017 (KR) 10-2017-0088308

(51) Int. Cl. G06K 9/62; G06K 9/32; G06K 9/40; G06K 9/46; G06K 9/00

(52) U.S. Cl. CPC G06K 9/6202; G06K 9/3233; G06K 9/00362; G06K 9/4633; G06K 9/6262; G06K 9/40

(57) ABSTRACT

The present disclosure provides a method and apparatus for identifying a target by obtaining mapping information between target images, generating philtrum model information for the target images, and determining a target included in a target image based on the mapping information and the philtrum model information.

### CROSS REFERENCE TO RELATED APPLICATION

The present application claims priority to Korean Patent Application No. 10-2017-0088308, filed Jul. 12, 2017, the entire contents of which is incorporated herein for all purposes by this reference.

### BACKGROUND OF THE INVENTION

### Field of the Invention

The present disclosure relates generally a method and apparatus for identifying a target using information included in a target image.

### Description of the Related Art

Muzzle patterns are used for identifying animals by printing the muzzle patterns on paper and by converting the patterns into generalized data. However, when printing muzzle patterns on paper, the skills of operators and additional process for datarizing the muzzle patterns printed on the paper are required, thus efficiency is decreased.

The foregoing is intended merely to aid in the understanding of the background of the present invention, and is not intended to mean that the present invention falls within the purview of the related art that is already known to those skilled in the art.

### SUMMARY OF THE INVENTION

A technical task of the present disclosure is to provide a method and apparatus for preventing the wrong extraction of a target feature point caused by reflection light included in a target image.

Another technical task of the present disclosure is to provide a method and apparatus for identifying a target using information included in a target image.

Still another technical task of the present disclosure is to provide a method and apparatus for increasing accuracy of identifying a target by comparing a global feature of a target image in addition to a local feature.

Technical tasks obtainable from the present disclosure are not limited by the above-mentioned technical task, and other unmentioned technical tasks can be clearly understood from the following description by those having ordinary skill in the technical field to which the present disclosure pertains.

In order to achieve the above object, according to one aspect of the present disclosure, there is provided a method of identifying a target, the method including: obtaining mapping information for a first target image with a second target image; generating philtrum model information about the first target image; and determining the target included in the first target image based on the mapping information and the philtrum model information.

According to one aspect of the present disclosure, the first target image may include an image of a target to be identified, and the second target image may include an image being a comparison target relative to the first target image. According to one aspect of the present disclosure, the philtrum model information may include information specifying a philtrum of the target included in the first target image.

According to one aspect of the present disclosure, the mapping information may represent a mapping relationship between a first area of the first target image and a second area of the second target image.

According to one aspect of the present disclosure, the first area may represent a feature point included within a region of interest (ROI) of the first target image, and the second area may represent a feature point included within a region of interest (ROI) of the second target image.

According to one aspect of the present disclosure, the obtaining the mapping information may include: setting the ROI in the first target image; determining a feature point of the target from the set ROI; and matching the determined feature point of the target with at least one second target image.

According to one aspect of the present disclosure, the setting the ROI in the first target image may include: removing noise included in the ROI; calculating an area occupied by reflection light in the ROI with the noise removed therefrom; and enhancing an edge, lost while removing the noise included in the ROI, by using an edge enhancement filter.

According to one aspect of the present disclosure, the determining the feature point of the target may include: extracting at least one pixel converging on the maximum intensity value among pixels positioned in the ROI; and determining the feature point of the target based on the extracted pixel.

According to one aspect of the present disclosure, the determining the feature point of the target may further include removing a feature point determined from the pixel converging on the maximum intensity value by reflection light.

According to one aspect of the present disclosure, the generating the philtrum model information may include: determining a philtrum neighboring area in the first target image; and determining a philtrum in the determined philtrum neighboring area.

According to one aspect of the present disclosure, the philtrum neighboring area may include a group of at least one pixel having an intensity value smaller than a predetermined intensity threshold value in the first target image.

According to one aspect of the present disclosure, the determining the philtrum neighboring area may include adjusting intensity of the first target image based on a predetermined parameter.

According to one aspect of the present disclosure, the predetermined parameter may include at least one of a contrast parameter α for contrast adjustment and a brightness parameter β for brightness adjustment.

According to one aspect of the present disclosure, the contrast parameter α may be variably derived based on at least one of the maximum intensity value of the first target image, the brightness parameter, and an intensity threshold value.

According to one aspect of the present disclosure, the determining the philtrum neighboring area may include performing a validity inspection to determine whether or not the determined philtrum neighboring area is valid for determining the philtrum.

According to one aspect of the present disclosure, the identifying the target may include: calculating a first result value by applying the mapping information to the philtrum model information about the first target image; calculating a second result value by applying the mapping information to the philtrum model information about the second target image; and determining whether or not the target of the first target image and the comparison target of the second target image are identical based on a difference between the first result value and the second result value.

According to one aspect of the present disclosure, the determining whether or not the target of the first target image and the comparison target of the second target image are identical may be determined based on whether or not the difference between the first result value and the second result value is equal to or less than a predetermined threshold value. According to one aspect of the present disclosure, the predetermined threshold value may include at least one of a length threshold value and an angle threshold value.

According to one aspect of the present disclosure, the predetermined threshold value may be variably determined based on a length of a biometric marker image included in the first target image.

The above briefly summarized features of the present disclosure are merely illustrative aspects of the detailed description of the present disclosure that will be described later and do not limit the scope of the present disclosure.

According to the present disclosure, accuracy of identifying a feature is improved by preventing the wrong extraction of a target feature caused by reflection light included in a target image.

According to the present disclosure, accuracy of identifying a target is improved by identifying the target based on a local feature or a global feature or both of the target included in a target image.

### BRIEF DESCRIPTION OF THE DRAWINGS

The above and other objects, features and other advantages of the present disclosure will be more clearly understood from the following detailed description when occupied in conjunction with the accompanying drawings, in which:

FIG. 1 is an embodiment to which the present invention is applied, and schematically shows a configuration of a target identifying apparatus 100 identifying a target in a target image based on philtrum model information;

FIG. 2 is an embodiment to which the present invention is applied, and shows a method of obtaining mapping information between target images in a mapping information obtaining unit 110;

FIG. 3 is an embodiment to which the present invention is applied, and shows a region of interest (ROI) in a target image;

FIG. 4 is an embodiment to which the present invention is applied, and shows a pre-processing process of the ROI;

FIGS. 5A to 5D are an embodiment to which the present invention is applied, and shows a process in which an area occupied by reflection light is enlarged by performing the pre-processing process of the ROI by using a target image with containing an animal muzzle pattern;

FIG. 6 is an embodiment to which the present invention is applied, and shows a pixel converging on the maximum intensity value in the ROI;

FIG. 7 is an embodiment to which the present invention is applied, and shows a method of generating the philtrum model information in a philtrum model information generating unit; and

FIG. 8 is an embodiment to which the present invention is applied, and shows a method of performing a validity inspection for a philtrum neighboring area.

### DETAILED DESCRIPTION OF THE INVENTION

Hereinafter, with reference to drawings, embodiments of the present disclosure are described in detail in a manner that one of ordinary skill in the art may perform the embodiments without undue difficulty. However, the described embodiments may be modified in various different ways, and are not limited to embodiments described hereinbelow.

To avoid obscuring the subject matter of the present disclosure, while embodiments of the present disclosure are illustrated, well known functions or configurations will be omitted from the following descriptions. The drawings and description are to be regarded as illustrative in nature and not restrictive. Like reference numerals designate like elements throughout the specification.

In the present disclosure, when an element is mentioned to be “coupled” or “connected” to another element, this may mean that it is directly coupled or connected to the other element, but it is to be understood that yet another element may exist in-between. In addition, it will be understood that the terms “comprises”, “comprising”, “includes”, “including” when used in this specification, specify the presence of one or more other components, but do not preclude the presence or addition of one or more other components unless defined to the contrary.

In the present disclosure, the terms first, second, etc. are used only for the purpose of identifying one element from another, and do not limit the order or importance, etc., between elements unless specifically mentioned. Therefore, within the scope of the present disclosure, a first component of an embodiment may be referred to as a second component in another embodiment, or similarly, a second component may be referred to as a first component.

In the present disclosure, the components that are distinguished from each other are intended to clearly illustrate each feature and do not necessarily mean that components are separate. In other words, a plurality of components may be integrated into one hardware or software unit or one component may be distributed into a plurality of hardware or software units. Thus, unless otherwise noted, such integrated or distributed embodiments are also included within the scope of the present disclosure.

In the present disclosure, the components described in the various embodiments are not necessarily essential components, and some may be optional components. Thus, embodiments including a subset of the components described in one embodiment are also included within the scope of this disclosure. Also, embodiments that include other elements in addition to those described in the various embodiments are also included within the scope of the present disclosure.

Hereinbelow, exemplary embodiments of the present disclosure will be described in detail.

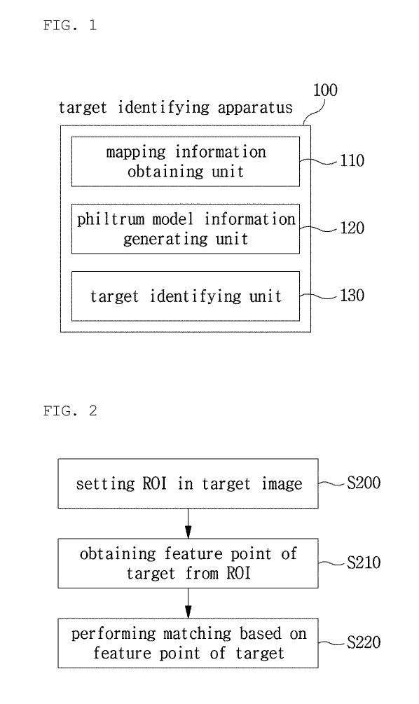

FIG. 1 is an embodiment to which the present invention is applied, and schematically shows a configuration of a target identifying apparatus 100 identifying a target in a target image based on philtrum model information.

Referring to FIG. 1, the target identifying apparatus 100 may include: a mapping information obtaining unit 110, a philtrum model information generating unit 120, and a target identifying unit 130.

The mapping information obtaining unit 110 may obtain mapping information between target images.

The target image may include one, two, or more target images. For example, the target image may include a first target image and a second target image. Hereinbelow, the target image is understood to include a first target image and a second target image.

The first target image may include an image of a target to be identified. The first target image may be an image pre-stored or input for identifying a target in a target identifying apparatus. The second target image may include an image that is a comparison target relative to the first target image. The second target image may include an image that is pre-stored in the target identifying apparatus for comparison with the first target image.

For this, the target identifying apparatus 100 may further include a target registering DB (not shown) storing the second target image. The target registering DB may be implemented by matching target information with a target image and by registering matched data by target. For example, in case of pets, when an owner of a pet transmits a target image of his or her pet in which a muzzle pattern is captured by using his or her terminal, the target registering DB may store target information including owner information including a name, an address, a phone-number of the pet's owner, and animal information including a type, a sex, vaccinations of a pet by matching the target information with the target image received from the terminal.

The mapping information may represent a mapping relationship between a first area of the first target image and a second area of the second target image. The first area and the second area may be respectively configured with one, two, or more pixels. A number of pairs of the first area and the second area having a mapping relationship therewith may be one, two, or more. In other words, the mapping information may represent a mapping relationship between a plurality of first areas and a plurality of second areas. The first area may represent a feature point included in the first target image or in a region of interest (ROI) within the first target image, and the second area may represent a feature point included in the second target image or in a region of interest (ROI) within the second target image.

The mapping information may be information transforming a position of the first area to a position of the second area, and represented as a transform matrix, a transform vector, etc. A method of obtaining the mapping information will be described in detail with reference to FIGS. 2 to 4.

Referring to FIG. 1, the philtrum model information generating unit 120 may generate philtrum model information about the target image.

The philtrum model information may include information specifying a philtrum of a target within the target image. For example, the philtrum model information may indicate a position, size, length, or width of the philtrum included in the target image. The philtrum model information may be represented as coordinates of one, two, or more pixels. The coordinates may include at least one of an x-coordinate and an y-coordinate.

The philtrum model information may be generated by determining a philtrum neighboring area in the target image, and by determining a philtrum area in the determined philtrum neighboring area. The philtrum model information may be respectively generated for the first target image and second target image. A method of generating the philtrum model information will be described in detail with reference to FIG. 7.

Referring to FIG. 1, the target identifying unit 130 may identify a target based on the mapping information and the philtrum model information.

In detail, a first result value may be calculated by applying the mapping information to the philtrum model information about the first target image. A second result value may be calculated by applying the mapping information to the philtrum model information about the second target image.

Whether or not the target of the first target image and the comparison target of the second target image are identical may be determined based on a difference between the first result value and the second result value. When the difference therebetween is equal to or less than a predetermined threshold value, the target of the first target image and the comparison target of the second target image are determined to be identical. Otherwise, the target of the first target image and the comparison target of the second target image are determined not to be identical. The predetermined threshold value may be a value pre-stored in the target identifying apparatus or may be variably determined based on a length of a biometric marker image included in the target image. The biometric marker image may be an image including a biometric marker having a unique pattern of an organism, and the biometric marker may include at least one of a face and a muzzle pattern of a target.

For example, the first result value and the second result value may respectively include at least one of a slope, an y-intercept, and an x-intercept of a philtrum line. When angles Θ respectively formed by a slope of a philtrum line of the first target image and a slope of a philtrum line of the second target image are equal to or less than an angle threshold value, the target of the first target image and the comparison target of the second target image may be determined to be identical. Otherwise, the target of the first target image and the comparison target of the second target image may be determined not to be identical. When a difference between an x-intercept of the first target image and an x-intercept of the second target image is equal to or less than a length threshold value, the target of the first target image and the comparison target of the second target image may be determined to be identical. Otherwise, the target of the first target image and the comparison target of the second target image may be determined not to be identical.

The target identifying apparatus 100 described above may be implemented by a web server or a cloud server proving a target identifying service to a user by being connected to a plurality of terminals through a wired/wireless network. However, it is not limited thereto. Herein, the terminal may refer to a smart-phone, a table PC, a wearable device operated by a veterinary clinic, an animal shelter, a pet's owner, a user using a user authentication service, but it is not limited thereto. The terminal may be extended to various devices including an image sensor capable of capturing a target image, and a communication function capable of receiving a target identifying service by transmitting the captured target image to the target identifying apparatus 100.

FIG. 2 is an embodiment to which the present invention is applied, and shows a method of obtaining the mapping information between target images in the mapping information obtaining unit 110.

Referring to FIG. 2, in step S200, a region of interest (ROI) may be set in a target image.

Herein, the target image may include a first target image that is the target to be identified described above, overlapping descriptions are omitted. The target image may be captured by a terminal operated by a veterinary clinic, an animal shelter, a pet's owner, and a user using a user authentication service. The target image may include a biometric marker such as face, muzzle pattern, etc. The face and the muzzle pattern are used as the biometric marker since a human may be recognized by using contours of the face, positions of eyes, nose, and mouth, iris, etc. included in the face, and an animal may be recognized by using a muzzle pattern that represents a unique pattern determined in an animal's nose. Herein, the face and the muzzle pattern are used as an example, but is not limited thereto. Various biometric markers capable of identifying a target may be included in the target image.

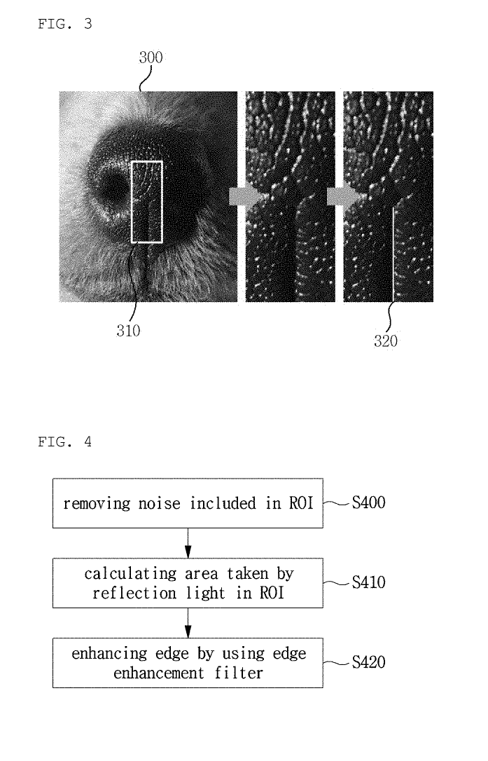

An area in which deformation due to a movement of the target in the target image with the biometric marker included therein is small may be set as the ROI. An area in which deformation due to the movement of the target in the target image is frequent may be a cause of decreasing the accuracy of identifying a target since the target image may be represented as other forms whenever capturing the target image and feature point information having different characteristics may be extracted even though the target image is captured with the identical target. Accordingly, it becomes a cause of decreasing the accuracy of identifying a target. Therefore, in the present embodiment, an area in which deformation in a size and form of a feature point of the target image is relatively small due to a movement of the target may be set as the ROI. This will be described with reference to FIG. 3.

Referring to FIG. 3, in a target image 300 in which a muzzle pattern of an animal is captured, since an outside area of the animal's nose may easily move by muscle movements of the animal, the corresponding area is not suitable for extracting a target feature point. An area between nostrils in which deformation in a size and form of a feature point in the target image 300 is relatively small may be set as an ROI 301. The ROI 301 may be set to include a philtrum 320 of the animal.

Meanwhile, in order to enlarge an area occupied by reflection light in the set ROI, a pre-processing for the set ROI may further performed. This will be described in detail with reference to FIG. 4.

Referring to FIG. 2, in step S210, a feature point of the target may be determined from the set ROI.

In detail, in a first step, at least one pixel converging on the maximum intensity value may be extracted by checking intensity values of pixels positioned in the ROI, and a feature point of the target may be determined based on the extracted pixel.

Herein, the feature point of the target may be determined by using a local feature extraction algorithm such as speeded-up robust feature (SUFR) algorithm that is obtained by speeding-up a scale invariant feature transform (SIFT) algorithm, but it is not limited thereto.

Herein, the maximum intensity value may vary according to a pixel depth. For example, in an 8-bit image, the maximum intensity value becomes 255 (in other words, 2⁸−1), and in a 10-bit image, the maximum intensity value becomes 1023 (in other words, 2¹⁰−1).

Pixels positioned in the area occupied by the reflection light in the ROI may be represented as a color close to a white color when compared with pixels positioned in other area. Accordingly, by checking the intensity values of pixels positioned in the ROI, pixels having intensity values of the top n % are extracted as pixels converging on the maximum intensity value.

An example of pixels extracted as the above method is shown in FIG. 6. Referring to FIG. 6, a pixel 600 is a pixel that is converged on the maximum intensity value due to the reflection light when capturing a target image, and which is different to an original intensity value of the pixel. In general, such a pixel or a neighboring pixel thereof or both may be a cause of decreasing the accuracy of identifying a target since there is high chance of extracting a wrong feature point therefrom.

Accordingly, when determining the feature point of the target in the ROI, a second step of removing the feature point extracted by the at least one pixel converging on the maximum intensity value by the reflection light may be further included.

By combining the first step and the second step which are described above, the feature point may be determined from the ROI of the target image. In addition, by removing the feature point from the pixel converging on the maximum intensity value by the reflection light, the accuracy of determining the feature point may be improved.

In other words, since the feature point of the target is accurately extracted from the image capturing the target, the method of determining the feature point according to the present invention may be applied to various application techniques requiring identification of animals such as animal registrations, identifications of lost animals, pet door locking apparatuses, etc.

Referring to FIG. 2, in step S220, matching may be performed based on the determined feature point of the target.

In detail, a feature point of the first target image that is the target to be identified and a feature point of the second target image that is the comparison target may be matched. The feature point of the second target image may be a feature point pre-stored in the target identifying apparatus 100 or in the target registering DB (not shown) which is described above. Alternatively, the feature point of the second target image may be determined by the above described first step, or by combining the first step and the second step.

Meanwhile, a result of the above matching may include an outlier that exceeds a normal distribution. Herein, the matching may further include removing the outlier from the matching result between the feature points. In order to remove the outlier, a random sample consensus (RANSAC) algorithm may be used, but it is not limited thereto.

Mapping information between the feature point of the first target image and the feature point of the second target image may be determined by using the above matching.

FIG. 4 is an embodiment to which the present invention is applied, and shows a pre-processing process of the ROI.

Referring to FIG. 4, in step S400, noise included in the ROI may be removed.

In detail, noise positioned in a small area such as salt and pepper noise may be removed by applying a noise removing filter to the ROI. When the noise removing filter is applied, noise relatively positioned in a large area in the ROI is gathered in one side. The noise removing filter may be a median filter, but it is not limited thereto.

Referring to FIG. 4, in step S410, an area occupied by reflection light in the ROI with the noise removed therefrom may be calculated.

In detail, the ROI with the noise removed therefrom is divided into a plurality of areas having a predetermined size, average intensity difference values of respective plurality of areas may be calculated based on differences between intensity values of pixels respectively positioned in the center of the plurality of areas and intensity values of pixels except for the center positioned pixels.

$$DSum = \frac{1}{9} {\sum }_{i = 0}^{i < 3} {\sum }_{j = 0}^{j < 3} \vert I ( 1 , 1 ) - I ( i , j ) \vert \qquad [ Formula 1 ]$$

Average intensity difference values of respective plurality of areas may be calculated by using the above Formula 1. For example, when the ROI with the noise removed therefrom is divided into a plurality of areas having a 3×3 size as shown in Formula 1, an average intensity difference value DSum of the 3×3 area may be calculated by performing a process of changing a difference between an intensity value of the center positioned pixel and intensity values of pixels except for the center positioned pixel into absolute values to all pixels within the 3×3 area, by adding absolute values thereof, and by calculating an average value of the added absolute values.

Herein, i and j may respectively indicate horizontal and vertical coordinate values of pixels positioned in respective plurality of areas. In addition, I(1,1) may refer to an intensity value of the center positioned pixel, and I(i,j) may refer to intensity values of pixels except for the center positioned pixel in the respective plurality of areas. Particularly, in Formula 1, the ROI with the noise removed therefrom is divided into areas having a 3×3 size, but it is not limited thereto. In other words, the ROI may be divided into areas having a n×m size, thus, 1/9 of Formula 1 may be changed to 1/(n*m).

When the average intensity difference values of respective plurality of areas are calculated, an area having an average intensity difference value smaller than a preset threshold value among the plurality of areas is determined, thus intensity values within the determined area may be replaced with the maximum value of a pixel among the intensity values of the pixels within the determined area.

I(i,j)=max(if DSum<Threshold) [Formula 2]

For example, when the average intensity difference value DSum of the 3×3 area calculated by using Formula 1 is smaller than a preset threshold value, the 3×3 area may be determined to be a flat area in which intensity changes within pixels are small. By using Formula 2, by replacing all pixels positioned within the 3×3 area with the maximum value of the pixel among the intensity values within the 3×3 area, the area occupied by the reflection light may be calculated.

Referring to FIG. 4, in step S420, the edge lost while removing the noise included in the ROI may be enhanced by using an edge enhancement filter.

As the edge enhancement filter, a sharpening spatial filter or an unsharp mask may be used, but it is not limited thereto. By enhancing the lost edge based on the edge enhancement filter, the area occupied by the reflection light in the ROI may be enlarged.

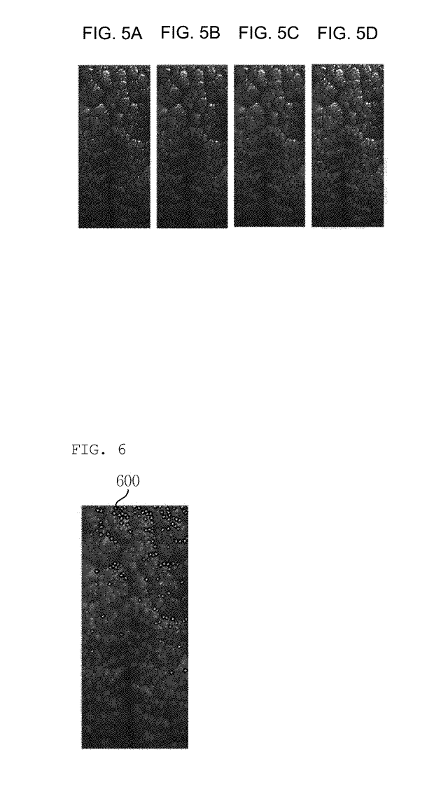

FIGS. 5A to 5D are an embodiment to which the present invention is applied, and shows a process in which the area occupied by reflection light is enlarged by performing the pre-processing process of the ROI by using a target image containing an animal muzzle pattern.

FIG. 5A is an area between nostrils, and is an original image of an ROI set in a target image in which a muzzle pattern of an animal is included. Referring to FIG. 5A, it may be confirmed that an area represented as white points caused by reflection light when capturing a target image is present in a large portion.

When a noise removing filter is applied to the target image, as shown in FIG. 5B, it may be confirmed that noises marked as small areas such as salt and pepper noise are removed, and areas marked in a large area remain.

When the noises marked as small areas are removed, the ROI may be divided into a plurality of areas. Average intensity difference values of respective plurality of areas are calculated, when the calculated average intensity difference values are smaller than a preset threshold value, thus all pixels positioned in the corresponding area is replaced with the maximum value. Accordingly, as shown in FIG. 5C, an area take by the reflection light may be calculated and gathered together.

When an edge is enhanced by applying an edge spatial filter to the target image of FIG. 5C, it may be confirmed that pixels converging to the maximum intensity value in the area occupied by the reflection light have emerged and have been marked as shown in FIG. 5D.

FIG. 7 is an embodiment to which the present invention is applied, and shows a method of generating the philtrum model information in the philtrum model information generating unit 120.

In the present embodiment, the philtrum model information may include information about philtrum properties included in a target image or in an ROI. The properties may include a position, a size, a length, a width, a depth, or a brightness of a philtrum. The philtrum model information may be generated by determining a philtrum included in the target image or in the ROI. The philtrum model information may be represented as one, two, or more coordinates of pixels, or may be represented as at least one of a slope, an x-intercept, and an y-intercept.

Referring to FIG. 7, in step S700, a philtrum neighboring area may be determined in the target image.

The target image includes a philtrum. Anatomically, a philtrum area between nostrils has a smaller intensity than a neighboring area thereof due to its depth. Accordingly, the philtrum neighboring area may be defined as a dark area corresponding to N % of a histogram of the target image. Alternatively, the philtrum neighboring area may include a group of at least one pixel having an intensity value smaller than a predetermined intensity threshold value Thresholdᵢₙₜ within the target image.

The intensity threshold value Thresholdᵢₙₜ may be derived based on Formula 3 below.

$$H = {\sum }_{i = 0}^{M} h ( i ) \qquad [ Formula 3 ]$$

Formula 3 is a formula representing a histogram H of the target image, i may refer to an intensity value, M may refer to the maximum intensity value of the target image, and h(i) may refer to each number of pixels having the intensity value closest to “N” may be calculated by accumulating the h(i) from being 0. The calculated i may be set as the intensity threshold value Thresholdᵢₙₜ.

Based on the set intensity threshold value Thresholdᵢₙₜ, a threshold value processing for the target image may be performed. Herein, the threshold value processing may refer to a process of replacing a pixel having an intensity value smaller than the intensity threshold value Thresholdᵢₙₜ with 0, and replacing a pixel having an intensity value greater than the intensity threshold value Thresholdᵢₙₜ with M. Thus, the target image may be binarized.

Meanwhile, the determining the philtrum neighboring area may further include adjusting intensity of the corresponding target image before determining the philtrum neighboring area. The adjusting the intensity may be performed by applying a predetermined parameter to an intensity value f(i,j) of a current pixel. The predetermined parameter may include at least one of a contrast parameter α for contrast adjustment and a brightness parameter β for brightness adjustment.

For example, the adjusting the intensity may be performed by using Formula 4 below.

g(i,j)=αf(i,j)+β [Formula 4]

In Formula 4, i and j may respectively refer to a raw position and a column position of the target image, f(i,j) may refer to an intensity value of a pixel before adjusting the intensity, and g(i,j) may refer to an intensity value of the pixel after adjusting the intensity. In addition, the α and the β may respectively represent a contrast parameter and a brightness parameter. The contrast/brightness parameters may be a fixed constant that is preset in the target identifying apparatus. The contrast parameter may be limited to be a constant greater than 0. The contrast parameter α may be variably derived based on at least one of the maximum intensity value M of the target image, the brightness parameter β, and the intensity threshold value Thresholdᵢₙₜ. For example, the contrast parameter α may be as Formula 5 below.

α=(M−β)/border [Formula 5]

In Formula 5, α may refer to a contrast parameter, M may refer to the maximum intensity value of the target image, β may refer to a brightness parameter, and border may refer to an intensity threshold value.

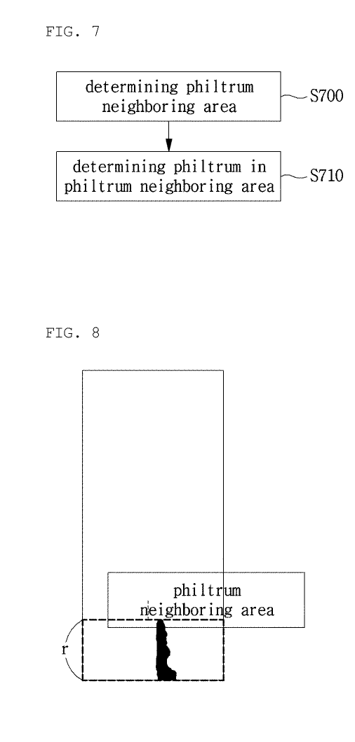

In addition, the determining the philtrum neighboring area may further perform a validity inspection to determine whether or not the determined philtrum neighboring area is valid for determining a philtrum. When the philtrum neighboring area becomes too small, the philtrum neighboring area may not be proper for determining the philtrum since there are many lost pieces of information. The validity inspection may be performed based on Formula 6 below, and will be described with reference to FIG. 8.

D=Iᵣ⊕Iᵣ^{w} [Formula 6]

In Formula 6, Iᵣ may refer to an r-th raw image of the target image, and Iᵣ^{w} may refer to an image of the r-th raw image changed with a white color. D may refer to a result of XOR calculation of two 2 target images. Herein, a range of r may be from the first raw to the last raw of the determined philtrum neighboring area as shown in FIG. 8.

As described above, the entire r-th raw of the target image is changed with a white color, 2 target images are compared by performing XOR calculation, and whether or not a philtrum area marked with a black color includes a white area may be inspected. When D is 0, (in other words, when two images are identical), it may refer that the philtrum neighboring area includes a white area. Herein, the predetermined philtrum neighboring area may be determined not valid for determining a philtrum.

At least one of the described adjusting the intensity and the validity inspection may be repeatedly performed by updating the N. Accordingly, the optimum philtrum neighboring area may be determined. The N may be updated in a range of 6.5 to 1.1, but it is not limited thereto. The optimum philtrum neighboring area may represent an area with a small N and without a white area within a philtrum neighboring area.

Referring to FIG. 7, in step S710, a philtrum may be determined within the determined philtrum neighboring area.

In detail, the determined philtrum neighboring area may be divided into a raw unit. The determined philtrum neighboring area may be classified into a left group including a first black coordinate of each raw, and a right group including the last black coordinate. For each group, a coordinate standard deviation (for example, an x-coordinate or an y-coordinate or both) may be calculated. A group having the smallest value among the calculated standard deviations may be determined as the philtrum model information.

Alternatively, a straight line obtained by approximating a group having the minimum value among the calculated standard deviations is determined, information indicating the determined straight line may be determined as the philtrum model information. In order to obtain the approximated straight line, a least square method may be used, but it is not limited thereto. The information indicating the straight line may include at least one of at least two coordinates, a slope, an x-intersect, and an y-intersect.

When generating the philtrum model information as described above, a part or the entire of the step S700 of determining the philtrum neighboring area may be omitted. According to the process described above, philtrum model information for the first target image that is the target to be identified and for the second target image that is the comparison target may be generated. Alternatively, the philtrum model information for the first target image may be generated by the above described process, and the philtrum model information for the second target image may be pre-stored in the target identifying apparatus 100.

The method shown in the present disclosure is described as a series of operations for clarity of description, and the order of steps is not limited. When needed, the steps may be performed at the same time or in a different order of steps. In order to implement the method according to the present disclosure, the steps may additionally include other steps, include the remaining steps except for some steps, or may include additional steps other than some steps.

The various embodiments of the disclosure are not intended to be exhaustive of all possible combinations and are intended to illustrate representative aspects of the disclosure. The matters described in the various embodiments may be applied independently or in a combination of two or more

In addition, the embodiments of the present disclosure may be implemented by various means, for example, hardware, firmware, software, or a combination thereof. In a hardware implementation, an embodiment of the present disclosure may be implemented by one or more ASICs (Application Specific Integrated Circuits), digital signal processors (DSPs), digital signal processing devices (DSPDs), programmable logic devices (PLDs), field programmable gate arrays (FPGAs), processors, controllers, microcontrollers, microprocessors, etc.

The scope of the present disclosure includes a software or machine-executable instructions (for example, operating system, applications, firmware, programs, etc.) that enables operations of the methods according to the various embodiments to be performed on a device or computer, and a non-transitory computer-readable medium in which such software or instructions are stored and are executable on a device or computer.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A method of identifying a target, the method comprising:
obtaining mapping information for a first target image with a second target image, wherein the first target image includes an image of a target to be identified, and the second target image includes an image being a comparison target relative to the first target image;
generating philtrum model information about the first target image, wherein the philtrum model information includes information specifying a philtrum of the target included in the first target image; and
determining the target included in the first target image based on the mapping information and the philtrum model information.

2. The method of claim 1, wherein the mapping information represents a mapping relationship between a first area of the first target image and a second area of the second target image.

3. The method of claim 2, wherein the first area represents to a feature point included within a region of interest (ROI) of the first target image, and the second area represents to a feature point included within a region of interest (ROI) of the second target image.

4. The method of claim 3, wherein the obtaining the mapping information includes:
setting the ROI in the first target image;
determining a feature point of the target from the set ROI; and
matching the determined feature point of the target with at least one second image.

5. The method of claim 4, wherein the setting the ROI in the first target image includes:
removing noise included in the ROI;
calculating an area occupied by reflection light in the ROI with the noise removed therefrom; and
enhancing an edge, lost while removing the noise included in the ROI, by using an edge enhancement filter.

6. The method of claim 4, wherein the obtaining the feature point of the target includes:
extracting at least one pixel converging on the maximum intensity value among pixels positioned in the ROI; and
determining the feature point of the target based on the extracted pixel.

7. The method of claim 6, wherein the determining the feature point of the target further includes: removing the feature point determined from the pixel converging on the maximum intensity value by reflection light.

8. The method of claim 1, wherein the generating the philtrum model information includes:
determining a philtrum neighboring area in the first target image; and
determining a philtrum in the determined philtrum neighboring area.

9. The method of claim 8, wherein the philtrum neighboring area includes a group of at least one pixel having an intensity value smaller than a predetermined intensity threshold value in the first target image.

10. The method of claim 9, wherein the determining the philtrum neighboring area includes: adjusting intensity of the first target image based on a predetermined parameter.

11. The method of claim 10, wherein the predetermined parameter includes at least one of a contrast parameter (α) for contrast adjustment and a brightness parameter (β) for brightness adjustment.

12. The method of claim 11, wherein the contrast parameter (α) is variably derived based on at least one of the maximum intensity value of the first target image, the brightness parameter, and an intensity threshold value.

13. The method of claim 8, wherein the determining the philtrum neighboring area includes performing a validity inspection to determine whether or not the determined philtrum neighboring area is valid for determining the philtrum.

14. The method of claim 1, wherein the identifying the target includes:
calculating a first result value by applying the mapping information to the philtrum model information about the first target image;
calculating a second result value by applying the mapping information to the philtrum model information about the second target image; and
determining whether or not the target of the first target image and the comparison target of the second target image are identical based on a difference between the first result value and the second result value.

15. The method of claim 14, wherein the determining of whether or not the target of the first target image and the comparison target of the second target image are identical is determined based on whether or not the difference between the first result value and the second result value is equal to or less than a predetermined threshold value.

16. The method of claim 15, wherein the predetermined threshold value includes at least one of a length threshold value and an angle threshold value.

17. The method of claim 15, wherein the predetermined threshold value is variably determined based on a length of a biometric marker image included in the first target image.
